(19) United States
(12) Patent Application Publication
(10) Pub. No.: US 2022/0057223 A1
(43) Pub. Date: Feb. 24, 2022

(54) METHOD FOR OPERATING AN AUTONOMOUS DRIVING VEHICLE AND AN AUTONOMOUS DRIVING VEHICLE

(71) Applicants: HYUNDAI MOTOR COMPANY, Seoul (KR); KIA MOTORS CORPORATION, Seoul (KR)

(72) Inventor: Thomas Schramm, Engelstadt (DE)

(73) Assignees: HYUNDAI MOTOR COMPANY, Seoul (KR); KIA MOTORS CORPORATION, Seoul (KR)

(21) Appl. No.: 16/951,659

(22) Filed: Nov. 18, 2020

(30) Foreign Application Priority Data
Aug. 24, 2020 (DE) 102020210716.5

(51) Int. Cl. G01C 21/34; G06Q 30/02; G06Q 10/06; B60W 60/00

(52) U.S. Cl. CPC G01C 21/3492; G06Q 30/0283; B60W 2555/60; B60W 60/00253; G06Q 10/06311

(57) ABSTRACT

A method for operating an autonomous driving vehicle waiting to pick-up a passenger at a pick-up location includes: determining a waiting time which the vehicle is required to wait for the passenger; determining a first and second route from an actual location of the vehicle to a parking spot and from there to the pick-up location; estimating parking cost based on the determined first and second routes and the waiting time; determining a third route from the actual location of the vehicle to the pick-up location by selecting a sequence of street segments from a plurality of pre-selected street segments such that a segment driving cost is minimized; estimating a driving cost for the third route based on the segment driving cost; comparing the estimated parking cost and the estimated driving cost; operating the vehicle to maneuver along the first and second routes when the estimated parking cost is lower than the estimated driving cost; and operating the vehicle to maneuver along the third route when the estimated driving cost is lower than the estimated parking cost.

### CROSS-REFERENCE TO RELATED APPLICATION

This application claims priority to and the benefit of German Patent Application No. 102020210716.5 filed Aug. 24, 2020, the entire contents of which are incorporated herein for all purposes and in its entirety by this reference.

### BACKGROUND

### 1. Technical Field

The present disclosure relates to a method for operating an autonomous driving vehicle that waits to pick-up a passenger at a predefined pick-up location.

### 2. Description of the Related Art

Autonomous driving vehicles or cars offer the possibility to transport a passenger to a desired location, where the passenger leaves the car, and to pick-up the passenger again after a certain time. In the meantime, the vehicle may be parked or may drive around.

Whether an autonomous driving vehicle parks itself or drives around while waiting for a passenger is not only a question of available parking spaces but also of parking fees and operational cost for driving.

Document US 2018/0376357 A1 discloses that, in an autonomous vehicle, parameters related to parking such as parking fees or public transit demands may be set. The vehicle may then use these parameters to determine actions which it shall take while waiting for a passenger, e.g. parking, charging, traveling, and the like.

### SUMMARY

It is one of the objects of the present disclosure to provide improved solutions for operating an autonomous driving vehicle while waiting to pick-up a passenger.

The present disclosure relates to a method of operating an autonomous driving vehicle and to an autonomous driving vehicle.

Further embodiments of the present disclosure are subject of the following description, referring to the drawings.

A first aspect of the disclosures relates to a method for operating an autonomous driving vehicle waiting to pick-up a passenger at a predefined pick-up location. The autonomous driving vehicle is also referred to as an “autonomous vehicle” and may be abbreviated as “AV”.

The method comprises determining a waiting time which the vehicle is required to wait for the passenger and determining a first route from an actual location of the vehicle to a parking spot and a second route from the parking spot to the pick-up location. Determining the waiting time may, for example, include retrieving a default time stored in a memory, e.g. 45 minutes, or receiving an input of the passenger. The first and second routes may be the shortest and/or the quickest possible routes to the next free parking spot and back to the pick-up location. Optionally, a parking time may be determined based on the determined first and second routes and the determined waiting time. For example, the time required for driving the first and second routes may be subtracted from the determined waiting time.

In a further step of the method, parking cost may be estimated or determined based on the determined first and second routes and the waiting time.

The method further includes determining a third route from the actual location of the vehicle to the pick-up location. It is to be noted that the actual location may be identical to the pick-up location. In this case, the third route is a route having a length greater than zero and the start and end point of the route being the pick-up location. Determining the third route includes pre-selecting a plurality of street segments leading from the actual location to the pick-up location based on the waiting time and an actual average driving speed possible in a respective street segment such that the vehicle reaches the pick-up location within the waiting time. Determining the third route also includes determining a segment driving cost for each pre-selected street segments and selecting a sequence of street segments from the plurality of pre-selected street segments such that a sum of the segment driving costs is minimized.

Pre-selecting the plurality of street segments may also be described as determining various possible routes via which the pick-up location can be reached within the waiting time when starting from the actual location of the AV. In this step, the actual possible average driving speed is taken into account. For example, the AV may receive values of the actual possible average driving speed in the respective street segments via a communication interface, for example, from other vehicles driving in this segment. Thereby, the required driving time may be estimated. The pre-selection of the street segments may be made under predefined boundary conditions. For example, pre-selection may be made from all street segments being in a predefined radius around the pick-up location, a predefined maximum length of the resulting route, or the like. From the pre-selected street segments, those segments are selected which allow operating the AV with lowest cost. One possible criterion for determining whether operational cost is high or low in a street segment may be the actual possible average driving speed of a street segment. For such a criterion, it can be assumed that a low possible average driving speed leads to low operational cost, whereas high possible average driving speed leads to high operational cost due to increased energy consumption and wear. For determining the third route, the method relates to the segment driving cost.

In a further step of the method, a driving cost for the third route is estimated or determined based on the segment driving costs, e.g. by summing up the segment driving costs of the selected street segments.

Furthermore, the method includes the steps of: comparing the estimated parking cost and the estimated driving cost; operating the vehicle to maneuver along the first and second routes when the estimated parking cost is lower than the estimated driving cost; and operating the vehicle to maneuver along the third route when the estimated driving cost is lower than the estimated parking cost. In other words, the vehicle determines whether it is more cost efficient to park itself or to drive around while waiting for the passenger.

According to a second aspect of the disclosure, a street vehicle configured for autonomous driving includes a control system configured to perform a method according to the first aspect of the disclosure.

It is one of the ideas of the disclosure to determine a cost optimized route along which the AV may drive while waiting for the passenger and compare the cost necessary for operating the AV on this cost optimized route with cost necessary for parking the AV while waiting for the passenger. The AV then is operated according to the variant with lower cost. The route along which the AV may drive while waiting for the passenger is determined by selecting street segments along which the AV may drive with low operational cost. The street segments are selected such that the AV reaches the pick-up location within the waiting time. Thus, an optimization of travel cost per time is performed.

One advantage of the disclosure is that lower operating costs of the vehicle are achieved while an on-time pick-up of the passengers is reliably achieved.

According to some embodiments, determining the segment driving cost for each street segment may include estimating an operational cost for driving the vehicle in the respective street segment with the actual average driving speed possible in this street segment. One advantage of this criterion is that those street segments in which the actual average driving speed is low are preferably selected. For example, street segments with a plurality of traffic lights, crossings, increased traffic, and the like are selected. Thus, the AV may be operated in these segments with low driving velocity and, thus, low operational cost.

According to some embodiments, determining the segment driving cost for each street segment may further include multiplying the estimated operational cost for driving the vehicle in the respective street segment with the actual average driving speed possible in this street segment with a weighting factor. Optionally, the weighting factor may lie within a range between 0.5 and 5. By applying a weighting factor, the segment driving cost may be increased above or decreased below the actual operational cost of the AV triggered by the technical state of the vehicle. Thus, a “fictive” or “virtual” cost is calculated. As a consequence, higher cost will be assumed for specific street segments and, therefore, those street segments will mostly be avoided. On the other hand, lower cost will be assumed for specific street segments and, therefore, those street segments will preferably be selected. Thereby, an easy and reliable method for avoiding or choosing specific street segments is provided.

According to some embodiments, the weighting factor depends on a speed limit prescribed for the respective street segment. According to some embodiments, the weighting factor decreases as the speed limit prescribed for the respective street segment increases. For example, residential areas such as play streets or streets with very low speed limits are made less attractive for selection by the described dependency of the weighting factor on the speed limit. Therefore, areas with playing children, pedestrians, and bicyclists on the road will reliably be avoided. Consequently, the AV may be operated with improved safety and negative publicity of AVs driving around and waiting for a passenger can be avoided.

According to some embodiments, the method may further include determining if another vehicle is present behind the autonomous driving vehicle, when the vehicle is maneuvered along the third route, and operating the autonomous driving vehicle to stop when it is determined that another vehicle is not present behind the autonomous driving vehicle. In other words, when the AV has determined that it is more cost efficient to drive around while waiting for the passenger, the AV may also stop, e.g. on a side of the street, when the traffic situation allows stopping. Optionally, it may further be determined if there is a parking spot or stand by spot, such as a shoulder, available in which the AV can stop. By stopping the AV, the driving cost may further be decreased.

According to some embodiments, the sequence of street segments from the plurality of pre-selected street segments are further selected such that one street segment is only driven once within a predetermined time limit. For example, it may be determined, with or without applying the weighting factor, that the third route includes one or more street segments having a low speed limit, e.g. a street passing through a residential area. In this case, in order to improve safety and avoiding negative publicity, it might be desired that the selected low speed limit segment is not frequently passed but only once in a specific time, e.g. once in 30 minutes.

According to some embodiments, estimating the parking cost includes summing an operating cost of the vehicle to drive the first and second routes and a parking fee due for a parking time in which the vehicle is parked.

According to some embodiments, estimating the driving cost includes summing the segment driving cost of the selected street segments of the third route and an amount of toll due for the third route.

The features and advantages described herein of the method are also disclosed for the vehicle and vice versa.

An autonomous driving vehicle or autonomous vehicle, within the scope of the present disclosure, may be defined as a vehicle, in particular a street vehicle, that includes an electronic controller configured to control propulsion, braking, and steering of the vehicle without interaction by a human driver. For example, the autonomous vehicle may include a sensor system configured to capture environmental data, such as actual position of the vehicle, distance to obstacles and other traffic participants, velocity and the like. The controller may be configured to generate control commands based on the captured environmental data to control propulsion, braking, and steering of the vehicle.

### BRIEF DESCRIPTION OF THE DRAWINGS

For a more complete understanding of the present disclosure and advantages thereof, reference is now made to the following description taken in conjunction with the accompanying drawings. The disclosure is explained in more detail below using specific embodiments, which are specified in the schematic figures, in which:

FIG. 1 shows a schematic view of an autonomous driving vehicle according to an embodiment of the disclosure;

FIG. 2 shows a street map in which a possible route of an autonomous driving vehicle waiting for a passenger may take when being operated in accordance with a method according to an embodiment of the disclosure;

FIG. 3 shows a flow chart of a method for operating an autonomous driving vehicle waiting to pick-up a passenger at a predefined pick-up location according to an embodiment of the disclosure; and

FIG. 4 shows a flow chart of method sub-steps of the method of FIG. 3.

Unless indicated otherwise, like reference numbers or signs in the figures indicate like elements.

### DETAILED DESCRIPTION OF THE EMBODIMENTS

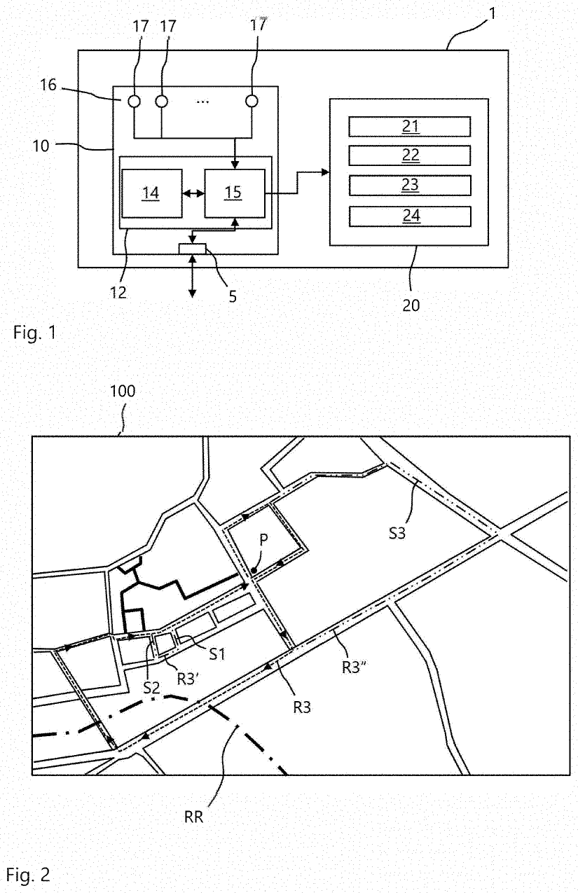

FIG. 1 shows by way of example a block diagram of an autonomous driving vehicle 1 or autonomous vehicle, AV. The AV 1 may, for example, be a street vehicle, in particular, a passenger vehicle, such as an automobile or a bus. As shown in FIG. 1, the AV 1 may include a control system 10 and a drive and steering system, DSS, 20.

As is schematically shown in FIG. 1, the control system 10 may include a control unit 12 having a memory 14 and a processor 15 and may include a sensor system 16 having a plurality of sensors 17.

The memory 14, for example, may be realized as a non-volatile data storage medium, such as a hard drive, a solid state drive, or the like, and may store software executable by the processor 15. The processor 15 may, for example, comprise one or more CPUs, an ASIC(s), FPGA(s), or the like. Generally, the processor 15 may be configured to generate output signals based on input data, e.g. by executing software stored in the memory 14.

The sensors 17 of the sensor system 16 may include one or more of distance sensors, e.g. radar or lidar sensors, position sensors, e.g. GPS sensors and/or inertial measurement units, velocity sensors, and the like. As is schematically shown in FIG. 1, the sensors 17 of the sensor system 16 may be connected to the control unit, e.g. via a BUS-system or via a wireless connection such as Wi-Fi. In particular, environmental data and/or vehicle related data captured by the sensors 17 may be input to the control unit 12. The processor 15 may generate output signals based on the input data received from the sensors 17.

As shown by way of example in FIG. 1, the vehicle 1 may further include a communication interface 5, which may optionally be part of the control system 10. The communication interface 5 may be connected to the control unit 12, as shown in FIG. 1 and serves to send data to and/or receive data from external data sources via a data network, such as the internet. External data sources may be, for example, servers, other vehicles, and the like.

As is shown in a simplified manner by way of example in FIG. 1, the DSS 20 may include components configured for accelerating, braking, and steering the AV 1, such as a motor 21, a transmission 22, wheel brakes 23, and a steering mechanism 24. As schematically shown in FIG. 1, the DSS 20 may be connected to the control unit 12, e.g. via a wire bound connection such as a BUS-system or via a wireless connection such as Wi-Fi. Based on the data captured by the sensors 17 and/or based on the data received via the communication interface 5, the control unit 12 may generate command signals to actuate the DSS 12. Thereby, the AV 1 may be operated autonomously by the control system 10.

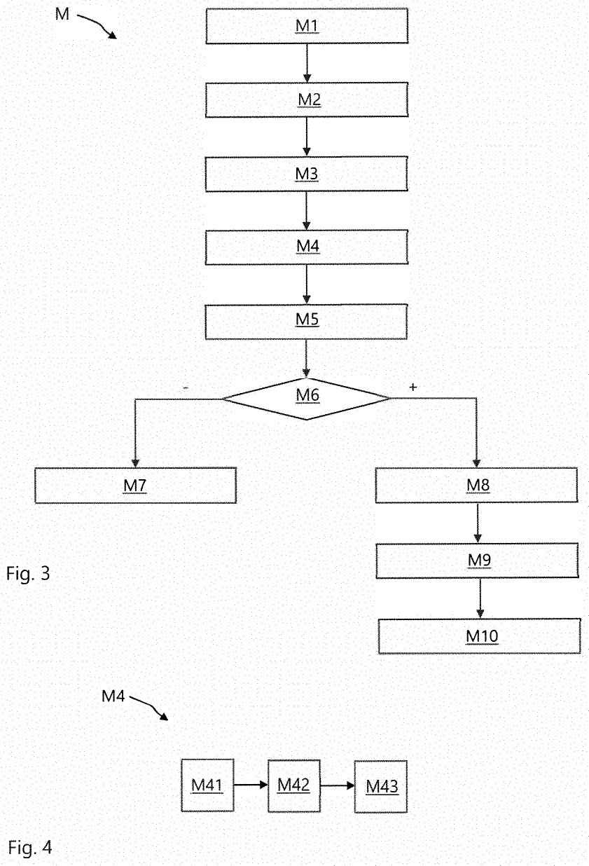

FIG. 3 shows a flow chart of an example of a method M for operating an AV 1 waiting to pick-up a passenger at a predefined pick-up location P. The method M may be realized by aid of the AV 1 shown in FIG. 1. For example, the memory 14 may store software executable by the processor 15 and causing the control system 10 to perform the steps M1-M10 of the method M.

When the AV 1 drops off a passenger at a drop-off location, the passenger may desire to be picked up again at a distinct time at a distinct pick-up location P, which may be identical or different from the drop-off location. In the meantime, the AV 1 may be required to wait for the passenger and has to take an appropriate action.

In the method M shown in FIG. 3, in first step M1, a waiting time, which the vehicle 1 is required to wait for the passenger, is determined. For example, a default time may be stored in the memory 14 of the control unit 12 of the AV 1 or the passenger may input a pick-up time to the control unit 12 via an input device (not shown). For example, the AV 1 may receive the pick-up time via the communication interface 5 from a smart phone or other handheld electronic device of the passenger.

In step M2, a first route from an actual location of the vehicle 1, e.g. the drop-off location, to a parking spot and a second route from the parking spot to the pick-up location is determined or calculated. For example, the first and second routes may be fastest possible or shortest possible routes to an available parking spot and from that parking spot to the pick-up location. The first and second routes may be determined on known route calculation algorithms. Optionally, a parking time may be calculated by subtracting the time required for travelling the first and second routes from the waiting time. A location of a free parking spot may, for example, be received via the communication interface from other vehicles driving around and notifying other vehicles of the free parking spaces.

In step M4, a parking cost is calculated or estimated based on the determined first and second routes and the waiting time. For example, the parking cost may be determined by summing an operating cost of the vehicle 1 to drive the first and second routes and a parking fee due for the parking time in which the vehicle 1 is parked. The parking fee may, for example, be received via the communication interface 5, for example, from a server of the parking spot provider. Operating cost of the vehicle 1 may include energy cost for propulsion of the vehicle and cost for wear of the vehicle 1. For example, a cost model may be stored in the memory 14. The cost model may define a functional relationship between average driving speed, travelling distance, and cost. Optionally, toll and other official fees for reaching the parking spot may also be taken into account in estimating the parking cost.

In step M4, a third route R3 from the actual location of the vehicle 1 to the pick-up location P is determined. One purpose of this step is to find a route along which the AV 1 may travel, with lowest possible cost, while waiting for the passenger so that it timely reaches the pick-up location P.

Step M4 may include sub-steps M41-M43 shown in FIG. 4. For example, in step M41, a plurality of street segments leading from the actual location of the AV 1 to the pick-up location P may be pre-selected based on the waiting time and an actual average driving speed possible in a respective street segment such that the AV 1 reaches the pick-up location P within the waiting time. In this step, the control unit 12 calculates or determines various possible routes the AV 1 may take while waiting, for example, based on one or more preconditions or criteria. For example, in step M41, the street segments making up the pre-selected routes, may be selected only from street segments being in a predefined radius around the pick-up location. The radius may optionally depend on the waiting time such that it increases with increasing waiting time and decreases with decreasing waiting time.

The street segments may be pre-selected in step M41 from a street map, e.g. in the form as schematically shown in FIG. 2. The street map may be stored in the memory 14 or may be received via the communication interface 5, for example.

In step M42, a segment driving cost for each pre-selected street segment is determined or calculated. Generally, determining, in step M42, the segment driving cost for each pre-selected street segment may include estimating an operational cost for driving the AV 1 in the respective road or street segment with the actual average driving speed possible in this street segment. For example, the control unit 12 may determine the cost necessary for operating the AV 1 in the pre-selected street segments, for example, based on the cost model stored in the memory 14, as described above. An actual possible average driving speed for each street segment may be received via the communication interface, e.g. from other vehicles driving in the pre-selected street segments.

Optionally, determining the segment driving cost for each street segment in step M42 may include multiplying the estimated operational cost for driving the vehicle 1 in the respective street segment with the actual average driving speed possible in this street segment with a weighting factor. For example, the control unit 12 may multiply the operational cost determined by means of the cost model with a weighting factor, which optionally lies within a range between 0.5 and 5. Thereby, the segment cost of a respective road or street segment may be increased or decreased, i.e., a weighted or fictive driving cost is calculated. For example, the weighting factor may optionally depend on a speed limit prescribed for the respective street segment. In particular, the weighting factor may decrease as the speed limit prescribed for the respective street segment increases. Thus, street segments with high speed limits, e.g. above 50 km/h, are multiplied with a small weighting factor, e.g. with a weighting factor smaller than one. Similar, street segments with low speed limits, e.g. below 30 km/h, are multiplied with a high weighting factor, e.g. with a weighting factor greater than one. Street segments with intermediate speed limits, e.g. between 30 and 50 km/h, may be multiplied with a weighting factor close to or equal to one. The speed limit may, for example, be assigned to each street segment within the street map.

Finally, in step M43, a sequence of street segments is selected from the plurality of pre-selected street segments such that a sum or total of the segment driving cost is minimized. For example, in the map 100 shown by way of example in FIG. 2, three potential third routes R3, R3′, and R3″ are shown, wherein route R3 is marked with dotted lines while routes R3′ and R3″ are marked with double dash dotted lines. The three routes R3, R3′, and R3″ have been determined in step M41 as potential third routes. In step M42, for each of the three routes R3, R3′, and R3″ the driving cost has been calculated. Finally, in step M43 the segments making up route R3 are selected as being the route with minimum total of segment driving costs. For example, route R3′ includes street segments S1 and S2 in which a very low speed limit is prescribed. Thus, these segments may account for high segment driving cost when a weighting factor is applied as described above and, consequently, are not selected. Route R3″ includes street segment S3, in which a high speed limit is prescribed and, consequently, a low weighting factor is valid. However, in street segment S3, the actual possible driving velocity may also by high, which tends to cause high operational cost, represented within the fictive or segment driving cost. Thus, segment S3 is also not selected. By contrast, route R3 includes street segments with low weighting factors and with low actual possible average driving speed, e.g. because of rail road RR crossings and a plurality of street crossings present. Thus, the street segments making up route R3 are selected in step M43.

Optionally, the sequence of street segments making up the third route R3 may be selected from the plurality of pre-selected street segments such that one street segment is only driven once within a predetermined time limit. For example, the whole route R3 may be traveled through several times. Similar, only a specific sequence of the street segments may be travelled several times. In order to avoid negative publicity and/or to avoid frequently traveling through street segments, which are often used by pedestrians, bicyclists, and the like, such street segments may only be travelled once in a predetermined time, e.g. only once in 30 minutes.

In step M5, a driving cost for the third route R3 based on the segment driving cost is calculated. For example, estimating, in step M5, the driving cost may include summing the segment driving cost of the selected street segments of the third route R3 and, optionally, an amount of toll due for the third route R3.

Further, in step M6, the estimated parking cost and the estimated driving cost are compared. For example, step M6 may comprise determining whether estimated driving cost is lower than the estimated parking cost. If the answer to this question is negative, i.e. when it is determined in step M6 that the estimated parking cost is lower than the estimated driving cost, as indicated by symbol “−” in FIG. 3, the method proceeds to step M7. In step M7, the control system 10 operates the AV 1 to maneuver along the first and second routes, that is, to proceed to a free parking spot, park itself for a parking time, and, subsequently, to proceed to the pick-up location P.

When it is determined in step M6 that the estimated driving cost is lower than the estimated parking cost, as indicated in FIG. 3 by symbol “+”, the method proceeds to step M8. In step M8, the control system 10 operates the AV 1 to maneuver along the third route R3. Should the case occur that the parking cost and the driving cost are equal to each other, the method may automatically proceed to step M7. It would also be possible to automatically proceed to step M8 instead.

When the AV 1 is operated to maneuver along the third route R3, optional method steps M9 and M10 may be carried out as schematically shown in FIG. 3. In step M9, it is determined if another vehicle is present behind the AV 1. For example, the sensor system 16 may detect other vehicles that follow the AV 1. The control unit 12 may determine from the captured sensor data presence of other vehicles. When it is determined, in step M9, that another vehicle is not present behind the AV 1, at least not within a predefined distance range, the control unit 10 may actuate the DSS 20 to stop the AV 1. Thereby, operational cost of the AV 1 is further decreased.

The disclosure has been described in detail referring to specific embodiments. However, it should be appreciated by those of ordinary skill in the art that modifications to these embodiments may be made without deviating from the principles and central ideas of the disclosure, the scope of the disclosure defined in the claims, and equivalents thereto.

### REFERENCE LIST

1 vehicle
5 communication interface
10 control system
12 control unit
14 memory
15 processor
16 sensor system
17 sensors
20 drive and steering system, DSS
21 motor
22 transmission
23 wheel brakes
24 steering mechanism
M method
M1-M10 method steps
M41-M43 method steps
P pick-up location
R3 third route
R3′, R3″ pre-selected routes
RR rail road
S1-S3 street segments

What is claimed:

1. A method for operating an autonomous driving vehicle waiting to pick-up a passenger at a predefined pick-up location, the method comprising:
determining a waiting time which the vehicle is required to wait for the passenger;
determining a first route from an actual location of the vehicle to a parking spot and a second route from the parking spot to the pick-up location;
estimating a parking cost based on the determined first and second routes and the waiting time;
determining a third route from the actual location of the vehicle to the pick-up location, wherein determining the third route includes pre-selecting a plurality of street segments leading from the actual location to the pick-up location based on the waiting time and an actual average driving speed possible in a respective street segment such that the vehicle reaches the pick-up location within the waiting time, determining a segment driving cost for each pre-selected street segment, and selecting a sequence of street segments from the plurality of pre-selected street segments such that a sum of the segment driving costs is minimized;
estimating a driving cost for the third route based on the segment driving costs;
comparing the estimated parking cost and the estimated driving cost;
operating the vehicle to maneuver along the first and second routes when the estimated parking cost is lower than the estimated driving cost; and
operating the vehicle to maneuver along the third route when the estimated driving cost is lower than the estimated parking cost.

2. The method according to claim 1, wherein determining the segment driving cost for each street segment includes estimating an operational cost for driving the vehicle in the respective street segment with the actual average driving speed possible in this street segment.

3. The method according to claim 2, wherein determining the segment driving cost for each street segment further includes multiplying the estimated operational cost for driving the vehicle in the respective street segment with the actual average driving speed possible in the respective street segment with a weighting factor.

4. The method according to claim 3, wherein the weighting factor lies within a range between 0.5 and 5.

5. The method according to claim 3, wherein the weighting factor depends on a speed limit prescribed for the respective street segment.

6. The method according to claim 5, wherein the weighting factor decreases as the speed limit prescribed for the respective street segment increases.

7. The method according to claim 1, further comprising:
determining if another vehicle is present behind the autonomous driving vehicle, when the vehicle is maneuvered along the third route; and
operating the autonomous driving vehicle to stop when it is determined that another vehicle is not present behind the autonomous driving vehicle.

8. The method according to claim 1, wherein the sequence of street segments from the plurality of pre-selected street segments are further selected such that one street segment is only driven once within a predetermined time limit.

9. The method according to claim 1, wherein estimating the parking cost includes summing an operating cost of the vehicle to drive the first and second routes and a parking fee due for a parking time in which the vehicle is parked.

10. The method according to claim 1, wherein estimating the driving cost includes summing the segment driving cost of the selected street segments of the third route and an amount of toll due for the third route.

11. A street vehicle configured for autonomous driving, the vehicle comprising:
a control system configured to perform the method according to claim 1.
